(19) United States
(12) Patent Application Publication
(10) Pub. No.: US 2017/0196265 A1
(43) Pub. Date: Jul. 13, 2017

(54) ELECTRONIC CIGARETTE AND AIR INTAKE VOLUME REGULATING METHOD FOR ELECTRONIC CIGARETTE

(71) Applicant: KIMREE HI-TECH INC., Tortola (VG)

(72) Inventor: Qiuming Liu, Shenzhen, Guangdong (CN)

(73) Assignee: KIMREE HI-TECH INC., Tortola (VG)

(21) Appl. No.: 15/314,113

(22) PCT Filed: May 28, 2014
(86) PCT No.: PCT/CN2014/078619

§ 371 Date: Nov. 28, 2016

(51) Int. Cl. A24F 47/00; F16K 15/02

(52) U.S. Cl. CPC A24F 47/008; F16K 15/02

(57) ABSTRACT

The present invention discloses an electronic cigarette and an air intake volume regulating method for the electronic cigarette. The electronic cigarette comprises an electronic cigarette body comprising a nozzle assembly, at least one atomization assembly and a battery assembly. The electronic cigarette body is provided with a connecting member and an adjusting member sleeved outside the connecting element. The adjusting member rotates in the circumferential direction of the connecting element to regulate a ventilation area at where a first air inlet channel is communicated with a second air inlet channel. The electronic cigarette body further comprises a positioning structure movably connected to the adjusting member and used for limiting the ventilation area of different gear positions. The electronic cigarette of the present invention is convenient to carry and the air intake volume is stable as well as easy adjustment.

### TECHNICAL FIELD

The present invention relates to a technical field of electronic heating products, and more particularly relates to an electronic cigarette and an air intake volume regulating method for the electronic cigarette.

### BACKGROUND

Illustrated as FIG. 1 which is an electronic cigarette in the prior art, the electronic cigarette comprises a smoking end 11, an atomizer 12 and a battery rod assembly 13 to which are connected mutually and disassembly, and an oil receiver 14 arranged inside the atomizer 12, the atomizer 12 and the battery rod assembly 13 are arranged co-axially to form an upper and lower serial connection of the oil receiver 14 and the battery rod assembly 13.

However, a mode of the serial connection of the oil storage device 14 and the battery rod assembly 13 makes the electronic cigarette body too long, inconvenient to carry and affects an overall appearance and a hand feeling of the electronic cigarette, when an accidental collision is happened, the electronic cigarette in the prior art is easily to be broken in a connection point of the atomizer 12 and the battery rod assembly 13.

Besides, a size of an air inlet of the electronic cigarette in the prior art is fixed and cannot be adjusted, if the air inlet is defined relatively small, it is easy to make a user feel that air is blocked and thus, it is not suitable for several users to use; if the air inlet is defined relatively big, then it is difficult to trigger airflow sensors to work, thus it is not suitable for an individual to use.

### SUMMARY

The technical problem that the present invention will solve is, aiming at the above-mentioned defect in prior art, to provide an electronic cigarette and an air intake volume regulating method for the electronic cigarette, where the electronic cigarette is easy to carry, can adjust the air intake volume and can avoid a change of the air intake volume due to a false touch of an adjusting member.

The technical solution that the present invention applies to solve the technical problem is: to provide an electronic cigarette, comprising an electronic cigarette body, an end of the electronic cigarette body is provided with a nozzle assembly, the electronic cigarette body is provided with at least one atomization assembly configured for atomizing tobacco oil and a battery assembly configured for supplying electrical power to each atomization assembly; a smoke channel is defined in the each atomization assembly to allow smoke produced by the each atomization assembly to flow through; one end of the smoke channel is communicated with the nozzle assembly; and a connecting member is defined at the electronic cigarette body, an adjusting member is sleeved on the connecting member and is configured to be rotated along a circumferential direction of the connecting member; a first air-inlet channel configured for outside air to inflow is defined on the adjusting member; a second air-inlet channel communicated with the first air-inlet channel and the smoke channel is defined on the connecting member; the adjusting member is rotated along a circumferential direction of the connecting member to adjust a ventilation area of a communicating part of the first air-inlet channel and the second air-inlet channel; the electronic cigarette body further comprises a positioning mechanism which is movably connected to the adjusting member and is configured for limiting the ventilation area in different gear positions.

The positioning mechanism comprises an elastic positioning portion fixed on the electronic cigarette body and multiple positioning holes arranged at an inner wall of the adjusting member; rotating the adjusting member to enable the elastic positioning portion to be optionally clamped into one of the positioning holes to keep the ventilation area in a corresponding gear.

The elastic positioning portion comprises a main body portion, an elastic portion and an abutting portion, an accommodation space configured for receiving the elastic portion and the abutting portion is defined inside the main body portion; one end of the elastic portion is abutted inside the accommodation space, while the other end of the elastic portion is connected to the abutting portion; one end of the abutting portion is movably defined inside the accommodation space while the other end of the abutting portion extends out of the main body portion.

The connecting member is provided with openings for the elastic positioning member to pass through; rotating the adjusting member, an end of the elastic positioning member passes through the openings, and under an action of an elastic restoring force of the elastic positioning member, the end of the elastic positioning member moves tightly close to an inner wall surface of the adjusting member until it is clamped into the positioning holes.

A limiting groove is arranged on the inner wall surface of the adjusting member, the electronic cigarette body is extended to form a limit stop block on an end surface close to the nozzle assembly; the adjusting member is rotated to move the limit stop block within a limiting range defined by the limit groove.

The first air-inlet channel comprises at least one group of first air inlets, each group of the first air inlets respectively comprises multiple first air inlets with different ventilation areas; the second air-inlet channel comprises second air inlets corresponding to the each group of the first air-inlets; rotating the adjusting member, each of the second air inlets can be optionally communicated with one of the each group of first air inlets to adjust the ventilation area at a communicating part of the first air inlets and the second air inlets.

Quantity of the second air inlets of the connecting member is equaled to quantity of groups of the first air-inlet on the adjusting member.

The second air-inlet channel comprises at least one group of second air inlets, each group of second air inlets respectively comprises multiple second air inlets with different ventilation areas; the first air-inlet channel comprises first air inlets corresponding to the each group of second air inlets; rotating the adjusting member, each of the first air inlets can be optionally communicated with one of the each group of second air inlets to adjust the ventilation area at a communicating part of the first air inlets and the second air inlets.

Quantity of the first air-inlets of the adjusting member is equaled to quantity of groups of the second air-inlet on the connecting member.

Two ends of the connecting member are detachably connected to the nozzle assembly and the electronic cigarette body respectively, the adjusting member is arranged at an end of the nozzle assembly which is opposite to a discharge opening of the electronic cigarette.

the electronic cigarette body comprises an installing support configured for receiving the atomization assembly and the battery assembly, the installing support comprises an internal support configured for accommodating and fixing the atomization assembly and the battery assembly, and an external support sleeved outside the internal support, the atomization assembly and the battery assembly are installed in parallel through the internal support, the positioning mechanism is fixed at an end of the internal support which is close to the connecting member.

The electronic cigarette body further comprises a base connected to the installing support, the base is provided with a control circuit and a charge base, the charge base is configured for charging the battery assembly, an end of the battery assembly extends into the base and is electrically connected to the control circuit.

The nozzle assembly comprises a nozzle sleeve and a nozzle cover, the nozzle cover comprises a nozzle external sleeve detachably and mutually connected to the connecting member, and a nozzle internal sleeve configured for smoke to flow out, the nozzle external sleeve is sleeved outside the nozzle internal sleeve, an end of the nozzle external sleeve which is opposite to the connecting member is connected to an end surface of the nozzle internal sleeve, the nozzle sleeve is fixed inside the nozzle internal sleeve.

The nozzle assembly further comprises a check valve for ensuring a one-way flow of the smoke, the check valve is fixed inside the nozzle internal sleeve, and an outer sidewall of the check valve and the inner wall surface of the nozzle internal sleeve are completely fitted.

The nozzle assembly further comprises a sealing piece installed at a gap between the nozzle internal sleeve and the nozzle external sleeve, an mounting hole configured for the nozzle internal sleeve to be inserted into is arranged at an end of the sealing piece, a gap between the mounting hole and the nozzle internal sleeve forms a smoke passage for smoke to pass through.

The each atomization assembly comprises a heating coil assembly, a tobacco oil latch member configured for providing the tobacco oil to the heating coil assembly, an atomization core configured for receiving the heating coil assembly and an atomization sleeve configured for installing the atomization core and the tobacco oil latch member, a first electrode and a second electrode which are configured for being electrically connected to the battery assembly are defined at an end of the atomization core, a through hole configured for an oil guide member of the heating coil assembly to pass through is arranged at a sidewall of the atomization core, two ends of the oil guide member are inserted into the tobacco oil latch member to absorb the tobacco oil, two ends of the heating coil assembly are electrically connected to the first electrode and the second electrode respectively.

The electronic cigarette body comprises multiple atomization assemblies which are arranged in parallel and multiple airflow sensors, the airflow sensors and the atomization assembles are distributed around a central axis of the electronic cigarette body, the atomization assemblies and the battery assembly are arranged in parallel.

A method for regulating air intake volume of the electronic cigarette, a smoke signal is sensed through airflow sensors which are provided in the electronic cigarette body to enable the battery assembly to supply electrical power to the atomization assembly to atomize the tobacco oil; according to a required air intake volume, the adjusting element is rotated along the circumferential direction of the connecting member to adjust the ventilation area at the communicating part of the first air-inlet channel and the second air-inlet channel, and the ventilation area is remained at a selected gear by the positioning mechanism.

The beneficial effects of implementing the electronic cigarette and the air intake volume regulating method for the electronic cigarette of the present invention are: the adjusting element is rotated along the circumferential direction of the connecting member to adjust the ventilation area at the communicating part of the first air-inlet channel and the second air-inlet channel, so as to meet requirements for different air intake volume of users; the positioning structure is arranged to further solidify the users' demands for different air intake volumes to limited gear positions, it is not only convenient for users to quickly select the air intake volume needed by themselves, but also avoid a change of the air intake volume due to the wrong touch of the adjusting member, it can effectively solve a problem of an uncontrollable position that an easy sliding of the adjusting member as it is contaminated by the tobacco oil; besides, as the atomization assembly and the battery assembly are arranged in parallel, then a total length of the electronic cigarette is reduced, and it is easy to carry with a skillful structure design and a well mechanical strength; meanwhile, a larger diameter of the electronic cigarette can increase a smoking and controlling pleasure to meet demands of users who usually smoke cigarettes with large diameters, such as cigars.

### BRIEF DESCRIPTION OF THE DRAWINGS

The present invention will be further described with reference to the accompanying drawings and embodiments in the following. in the drawings:

FIG. 1 is a schematic diagram of structure of an electronic cigarette in the prior art;

FIG. 2 is a block diagram of an electronic cigarette in a first embodiment of the present invention;

FIG. 3 is an explosion diagram of the electronic cigarette in FIG. 2;

FIG. 4 is a diagram of inner structures of the electronic cigarette in FIG. 2;

FIG. 5 is a cross-section view along A-A direction of the electronic cigarette in FIG. 4;

FIG. 6 is a block diagram of an adjusting member of the electronic cigarette in FIG. 2;

FIG. 7 is a block diagram of a connecting member of the electronic cigarette in FIG. 2;

FIG. 8 is a block diagram of an assembly of the adjusting member and the connecting member of the electronic cigarette in FIG. 2;

FIG. 9 is a block diagram of an elastic positioning portion of the electronic cigarette in FIG. 2;

FIG. 10 is a sectional view of the electronic cigarette in FIG. 2;

FIG. 11 is a schematic diagram of air flows inside the electronic cigarette in FIG. 2;

FIG. 12 is a block diagram of an electronic cigarette in a second embodiment of the present invention;

FIG. 13 is a diagram of inner structures of the electronic cigarette in FIG. 12;

FIG. 14 is a cross-section view along B-B direction of the electronic cigarette in FIG. 13;

FIG. 15 a block diagram of an adjusting member of the electronic cigarette in FIG. 12;

FIG. 16 is a block diagram of a connecting member of the electronic cigarette in FIG. 12;

FIG. 17 is a block diagram of an assembly of the adjusting member and the connecting member of the electronic cigarette in FIG. 12.

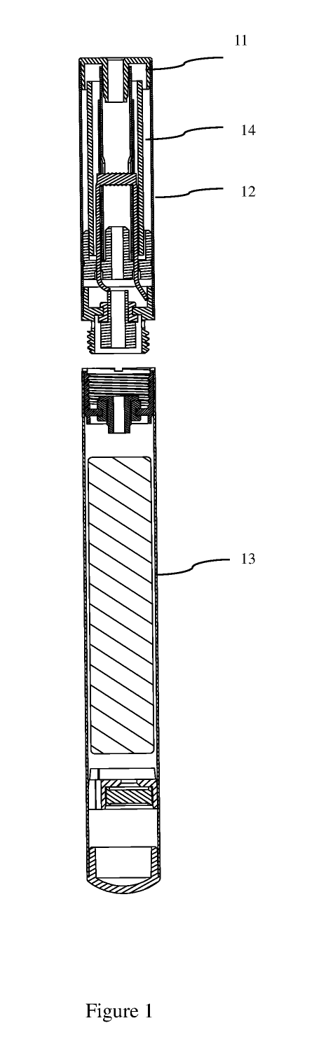

### DETAILED DESCRIPTION OF THE PREFERRED EMBODIMENT

In order to better understand the technical features, purpose and effect of the present invention, the preferred embodiment will be described in detail in the following.

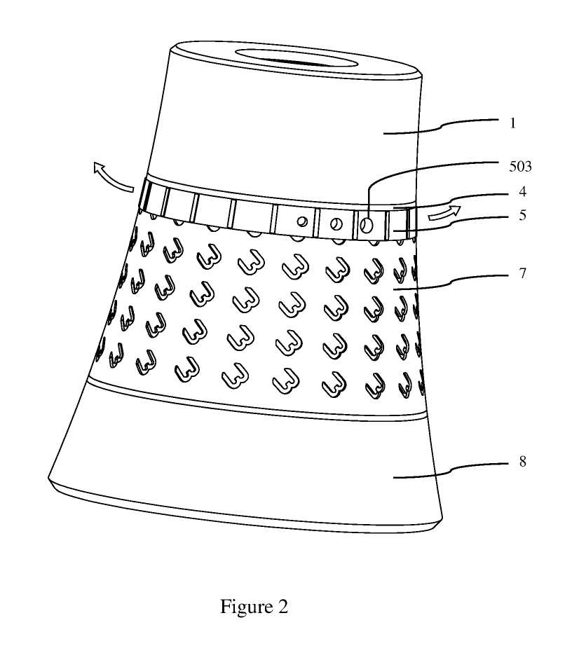

FIGS. 2 to 11 show the electronic cigarette provided by the first embodiment of the electronic cigarette, the electronic cigarette comprises an electronic cigarette body and a nozzle assembly 1 defined at an end of the electronic cigarette body, the electronic cigarette body is provided with at least one atomization assembly 2 configured for atomizing tobacco oil and a battery assembly 3 configured for supplying electrical power to each atomization assembly 2; a smoke channel is defined in the each atomization assembly 2 to allow smoke produced by the each atomization assembly 2 to flow; one end of the smoke channel is communicated with the nozzle assembly 1; and a connecting member 4 is defined between the electronic cigarette body and the nozzle assembly 1, an adjusting member 5 is sleeved on the connecting member 4 and is configured to be rotated along a circumferential direction of the connecting member 4; a first air-inlet channel configured for outside air to inflow is defined on the adjusting member 5; a second air-inlet channel communicated with the first air-inlet channel and the smoke channel is defined on the connecting member 4; the adjusting member 5 is rotated along a circumferential direction of the connecting member 4 to adjust a ventilation area of a communicating part of the first air-inlet channel and the second air-inlet channel. Besides, the electronic cigarette body further comprises a positioning mechanism which is movably connected to the adjusting member 5 and is configured for limiting the ventilation area in different gear positions.

As shown in FIG. 2, the electronic cigarette body further comprises an installing support 7 configured for receiving the atomization assembly 2 and the battery assembly 3, and a base 8 for preventing the atomization assembly 2 and the battery assembly 3 from falling out of the installing support 7.

The adjusting member 5 is annular in shape, at least one group of first air inlets 503 is defined at the adjusting member 5, each group of the first air inlets 503 respectively comprises multiple first air inlets 503 with different ventilation areas, in the present embodiment, the each group of first air inlets 503 comprises three first air inlets 503 with different ventilation areas. Besides, the adjusting member 5 can be rotated clockwise or counterclockwise around the connecting member 4 along the circumferential direction of the connecting member 4.

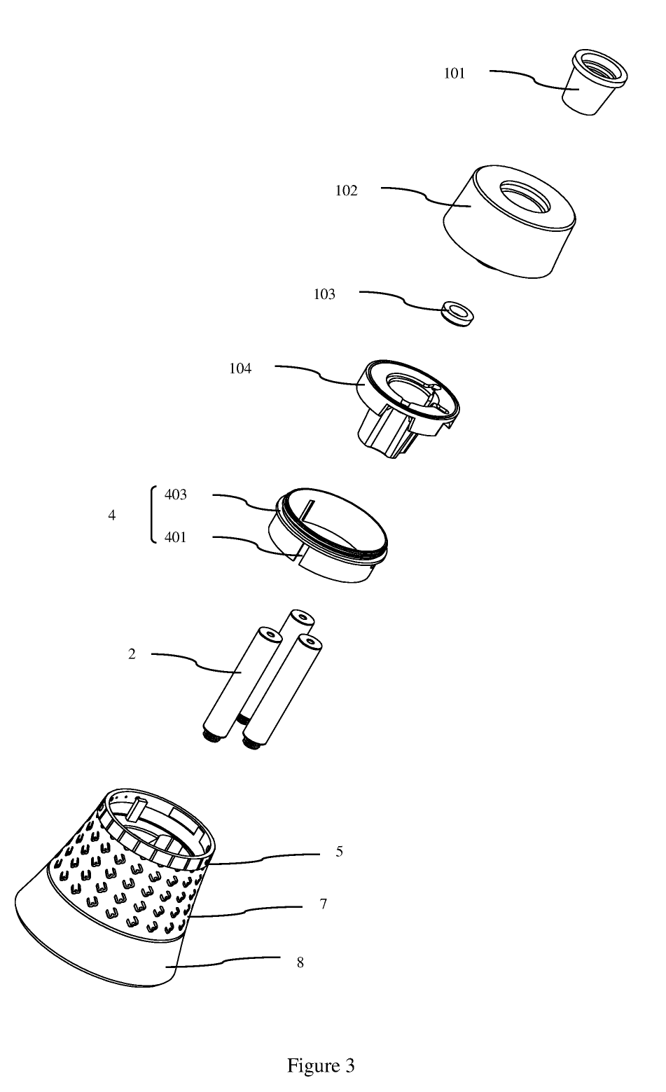

As shown in FIG. 3, the nozzle assembly 1 comprises a nozzle sleeve 101 configured for inhaling the smoke by users, a nozzle cover 102, a check valve 103 configured for ensuring a one-way flow of the smoke, and a sealing piece 104 configured for preventing a leakage of the smoke.

Two ends of the connecting member 4 are detachably and mutually connected to the nozzle assembly 1 and the electronic cigarette body respectively, the adjusting member 5 is located at an end of the nozzle assembly 1 which is opposite to a discharge opening (not shown in Figures) of the electronic cigarette, this configuration can avoid the air-inlet channels being stuck by mouth and saliva in the mouth when smoking. In the present embodiment, the connecting member 4 is generally an annular casing structure, the connecting member 4 extends outwards from a periphery of its outer wall to form a clapboard 403, take the clapboard 403 as a boundary, the connecting member 4 is provided with an external thread structure at a side close to the nozzle assembly 1, and multiple openings 401 are evenly arranged at a side of the connecting member 4 close to an installing support 7. Understandably, in other embodiments, the connecting member 4 also can be configured as an integral forming structure with the installing support 7, and it is not limited here.

In the present embodiment, in order to avoid that amount of smoke provided by a single atomization assembly 2 is not sufficient when the electronic cigarette is use by multiple users, multiple atomization assemblies 2 are defined inside the electronic cigarette body to meet demands of multiple users at the same time.

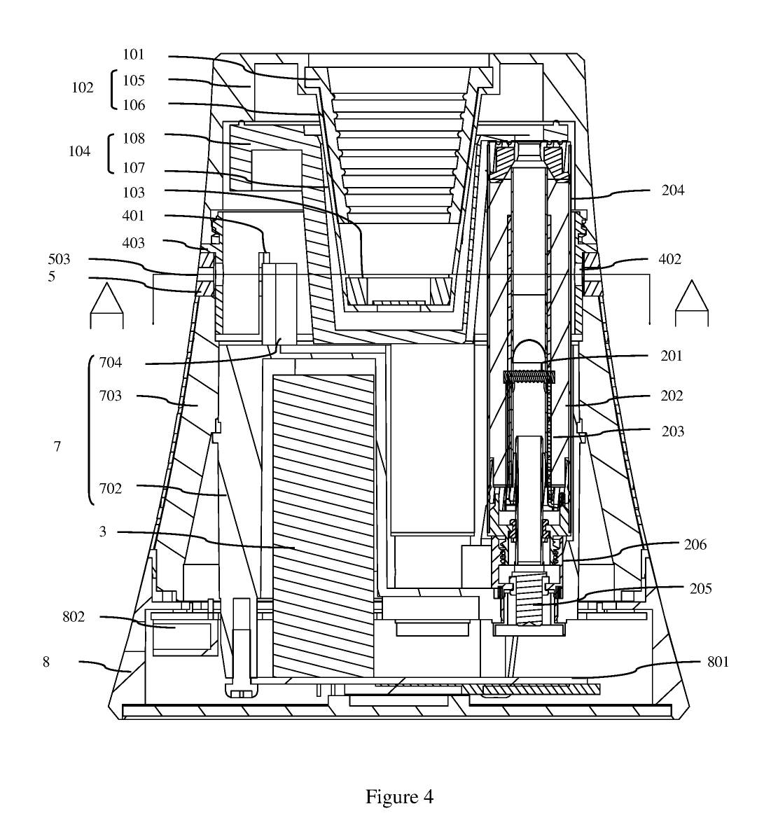

As shown in FIG. 4, the nozzle cover 102 is preferably to be an integral forming structure, comprises a nozzle external sleeve 105 disassembly and mutually connected to the connecting member 4, and a nozzle internal sleeve 106 configured for smoke to flow out, the nozzle external sleeve 105 is sleeved outside the nozzle internal sleeve 106, an end of the nozzle external sleeve 105 which is opposite to the connecting member 4 is connected to an end surface of the nozzle internal sleeve 106. A diameter of the nozzle external sleeve 105 is reduced in a direction which is opposite to the connecting member 4, a diameter of the nozzle internal sleeve 106 is reduced in a direction towards the connecting member 4, and a through hole configured for smoke to pass through is defined at an end surface of the nozzle internal sleeve 106 close to the connecting member 4. Besides, the nozzle external sleeve 105 is sleeved outside the nozzle internal sleeve 106, an end of the nozzle external sleeve 105 which is opposite to the connecting member 4 is connected to an end surface of the nozzle internal sleeve 106, the nozzle sleeve 101 is firmly fixed inside the nozzle internal sleeve 106.

The nozzle sleeve 101 is preferably to be a tubular structure made of silica gel material, its inner side wall is provided with a thread structure for connecting an external tube (not shown in Figures) for one or more persons to use, or the thread structure defined by the inner wall of the nozzle sleeve 101 is connected to and cooperated to use with an existing hookah (not shown in Figures). A diameter of the nozzle sleeve 101 is reduced along the direction close to the connecting member 4, and an outer wall of an end of the nozzle sleeve 101 extends out to form a convex flange, a connecting point of the nozzle internal sleeve 106 and the nozzle external sleeve 105 is provided with a groove for clamping the convex flange to fix the nozzle sleeve 101. An outer sidewall of nozzle sleeve 101 is tightly fitted with an inner sidewall of the nozzle internal sleeve 106.

The check valve 103 is clamped and fixed in the nozzle internal sleeve 106 for ensuring a one-way flow of the smoke, its outer sidewall is tightly fitted with an inner sidewall of the nozzle internal sleeve 106 to avoid that the smoke leaks along the gap between the two, and its end surface is fitted with an end surface of the nozzle internal sleeve 106, when the check valve 103 is opened, openings arranged on the check valve 103 are communicated with the first through hole to allow smoke to pass through. When users inhale, the check valve 103 is opened, the smoke can pass through the first through hole and the check valve 103 to enter the nozzle internal sleeve 106 to be inhaled by the users; when users stop inhaling, the check valve 103 closes automatically to avoid the smoke to flow into the nozzle internal sleeve 106.

The sealing piece 104 is installed at a gap between the nozzle internal sleeve 106 and the nozzle external sleeve 105, an mounting hole 107 configured for the nozzle internal sleeve 106 to be inserted into is arranged at an end of the sealing piece 104, a gap between an inner wall of the mounting hole 107 and an outer wall of the nozzle internal sleeve 106 forms a smoke channel for smoke to pass through, and an outer sidewall of the opening extends outwards to form a ring fixed flange 108.

An end surface of the nozzle external sleeve 105 is abutted against one side of the clapboard 403 on the connecting member 4, at least one second air inlet 402 is defined on a sidewall of the connecting member 4, the adjusting member 5 is sleeved outside the connecting member 4, and the adjusting member 5 is abutted against the other side of the clapboard 403.

The installing support 7 comprises an internal support 702 configured for accommodating and fixing the atomization assembly 2 and the battery assembly 3, and an external support 703 sleeved outside the internal support 702, the atomization assembly 2 and the battery assembly 3 are installed in parallel through the internal support 702. In the present embodiment, the atomization assembly 2 and the battery assembly 3 are installed in parallel. Certainly, in other embodiments, the atomization assembly 2 and the battery assembly 3 can be installed in non-parallel as well, besides, the nozzle assembly 1 can also be arranged to other shapes or structures according to actual demands, as long as it is convenient for the user to smoke or for connecting to the existing hookah or straws, the structure of the nozzle assembly 1 has no limitations here.

The atomization assembly 2 is a vulnerable part., it is convenient for users to exchange the atomization assembly 2 by detachably installing the atomization assembly 2 in the internal support 702. The atomization assembly 2 comprises a heating coil assembly 201, a tobacco oil latch member 202 which is made of cotton or fibers and configured for providing the tobacco oil to the heating coil assembly 201, the heating coil assembly 201 comprises an oil guide member and a heating coil around an outer part of the oil guide member. Besides, the atomization assembly 2 further comprises an atomization core 203 configured for receiving the heating coil assembly 201, and an atomization sleeve 204 configured for installing the atomization core 203 and the tobacco oil latch member 202, the tobacco oil latch member 202 is defined between the atomization core 203 and the atomization sleeve 204, and the tobacco oil latch member 202 is fitted with an outside wall of the atomization core 203 and an inside wall of the atomization sleeve 204 respectively. A through hole configured for an oil guide member of the heating coil assembly 201 to pass through is arranged at a sidewall of the atomization core 203, two ends of the oil guide member are inserted into the tobacco oil latch member 202 to absorb the tobacco oil, the heating coil is arranged around the outer part of the oil guide member to atomize the tobacco oil provided by the oil guide member. A first electrode 205 and a second electrode 206 which are electrically and respectively connected to the heating coil assembly 201 and the battery assembly 3 are defined at an end of the atomization core 203 which is close to the base 8. Understandably, an insulating part is arranged between the first electrode 205 and the second electrode 206. Certainly, the atomization assembly 2 is not limited to the above structures, as long as the atomization assembly 2 can atomize the tobacco oil, for instance, the tobacco oil latch member 202 can be replaced by a tobacco oil bottle, and so on, it is not limited here.

Furthermore, an end of the atomization assembly 2 which is opposite to the base 8 is abutted against the fixed flange 108 of the sealing piece 104, and the fixed flange 108 is provided with through holes to allow the smoke in the atomization assembly 2 to flow through.

The base 8 is provided with a control circuit 801 and a charge base 802, the control circuit 801 is fixed by screws and is electrically connected to the charge base 802, the battery assembly 3 is detachably connected in the internal support 702 and an end of the battery assembly 3 extends into the base 8 and is electrically connected to the control circuit 801.

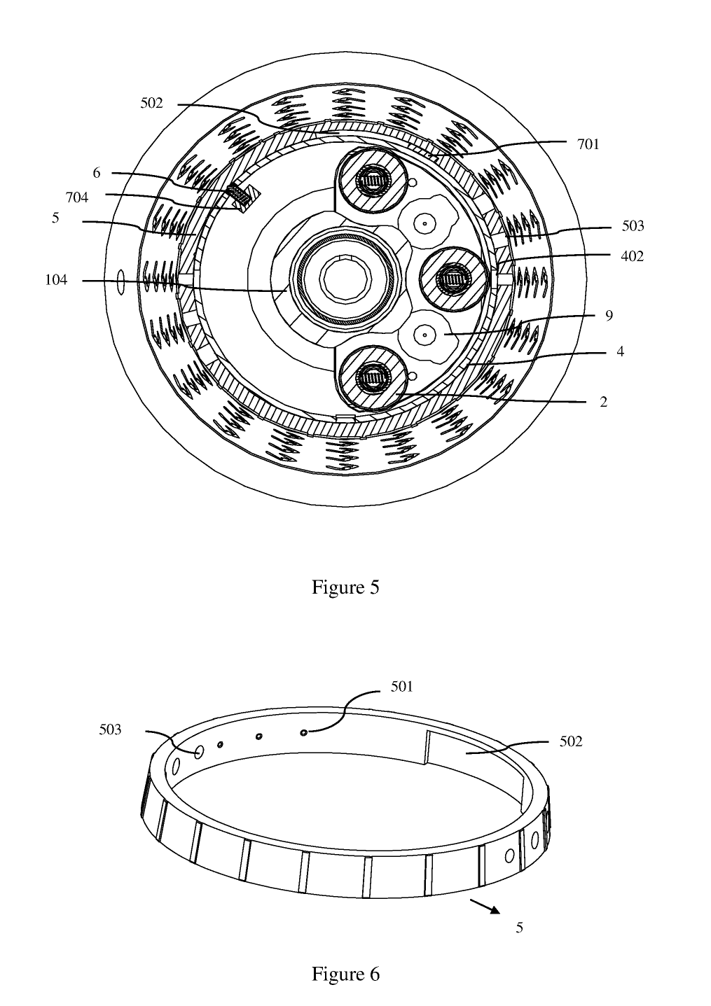

As illustrated by FIG. 5, to meet needs for multiple users to inhale at the same time, three atomization assemblies 2 are arranged in parallel in the electronic cigarette of the present embodiment, and two airflow sensors 9 are arranged between the atomization assemblies 2, the airflow sensors 9 and the atomization assembles 2 are distributed around a central axis of the electronic cigarette body,

Though holes are defined on the fixed flange 108 of the sealing piece 104 to ensure multiple atomization assemblies 2 can work at the same time, each one of the through holes is corresponding to each of the atomization assemblies 2. Understandably, quantity of the atomization assemblies 2 and the airflow sensors 9 is not limited to specific numbers in the present embodiment, it can be increased or reduced according to actual needs as well.

Multiple groups of first air inlets 503 are defined at the adjusting member 5, and multiple second air inlets 402 are correspondingly defined at the connecting member 4; preferably, quantity of the second air inlets 402 is equaled to quantity of groups of the first air-inlets 503, which means that, each group of the first air-inlets 503 is corresponding to one second air inlet 402.

An end surface of the installing support 7 which is close to the connecting member 4 is extended to form a fixing support 704 and a limit stop block 701; an elastic positioning portion 6 is defined on the fixing support 704, spring or other elastic pieces are received in the elastic positioning portion 6. A limiting groove 502 and positioning holes 501 are arranged at an inner wall of the adjusting member 5 which is fitted with the connecting member 4, when the adjusting member 5 is rotated, the limit stop block 701 is moved within a limiting range defined by the limit groove 502 to ensure all of the first air inlets 503 in each group of the first air inlets 503 can be communicated with the corresponding second air inlets 402 respectively by rotating the adjusting member 5 within the limiting range. when the adjusting member 5 is rotated, under an action of spring inside the elastic positioning member 6, the elastic positioning member 6 moves tightly close to an inner wall surface of the adjusting member 5, when the elastic positioning member 6 is rotated to the positioning holes 501, the elastic positioning member 6 is clamped into one of the positioning holes 501 under the action of spring, then the second air inlet 402 is communicated with the first air inlets 503.

Preferably, as shown in FIGS. 6 and 7, quantity of positioning holes 501 on the adjusting member 5 is equaled to that of the first air inlets 503 included in each group of the first air inlets 503, quantity of the second air inlets on the connecting member 4 is equaled to that of groups of the first air inlets 503 on the adjusting member 5.

In the present embodiment, two groups of the first air inlets 503 are defined on the adjusting member 5, each group contains three first air inlets 503 respectively; correspondingly, three positioning holes 501 are defined on the adjusting member 5, and two second air inlets 402 are defined on the connecting member 4. Rotating the adjusting member 5, when the elastic positioning member 6 is clamped into one of the positioning holes 501, each of the second air inlets 402 is communicated with one of the first air inlets 503 in one corresponding group of the first air inlets 503.

Understandably, quantity of groups of the first air inlets 503 and first air inlets 503 in each group is selected according to actual needs, and it is not limited here.

Also, it can be understood that diameters of multiple first air inlets 503 in each group can be increased or reduced along a clockwise direction, also can be an irregular distribution, a regularity of a distribution of the first air inlets 503 with different diameters is not limited here.

Positioning mechanism comprises the elastic positioning member 6 installed on the fixing support 704 and positioning holes 501 arranged on the inner sidewall of the adjusting member 5, rotate the adjusting member 5 to the enable the elastic positioning portion 6 to be optionally clamped into one of the positioning holes 501 to keep the ventilation area in corresponding gear. The setting of the positioning mechanism can be solidified in a limited number of gears with users' demands of different air intake volume, it is not only convenient for users to quickly select the air intake volume required by themselves, but also can avoid a change of the air intake volume caused by a false touch of the adjustment member 5.

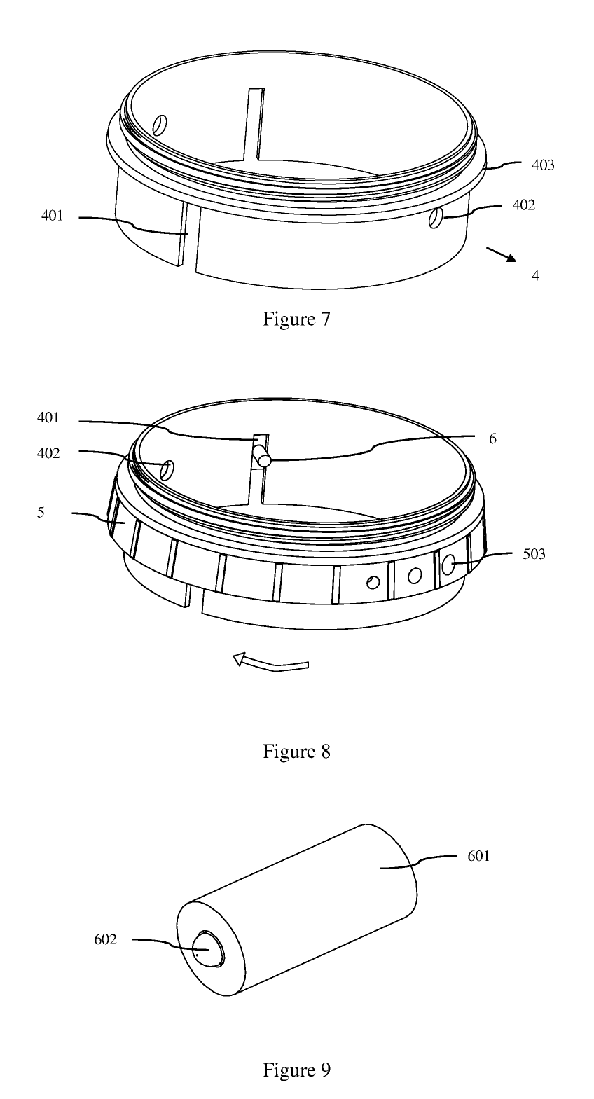

As shown in FIG. 8, the adjusting member 5 is sleeved outside the connecting member 4, the elastic positioning portion 6 is passed through the openings 401 on the connecting member 4 and abutted against the inner sidewall of the adjusting member 5 under a support of the fixing support 704 (not shown in FIG. 8).

As shown in FIG. 9, the elastic positioning portion 6 comprises a main body portion 601 configured to cover an elastic portion such as spring and an abutting portion 602 extended from a through hole defined on an inner sidewall of the main body portion 601, the abutting portion 602 is abutted against an inner elastic portion; under an elastic action of the elastic portion, the abutting portion 602 can extend out of the main body portion 601 or retract inside the main body portion 601 as well. Understandably, the elastic portion can be elastic rubber, spring and so on, it is not limited here.

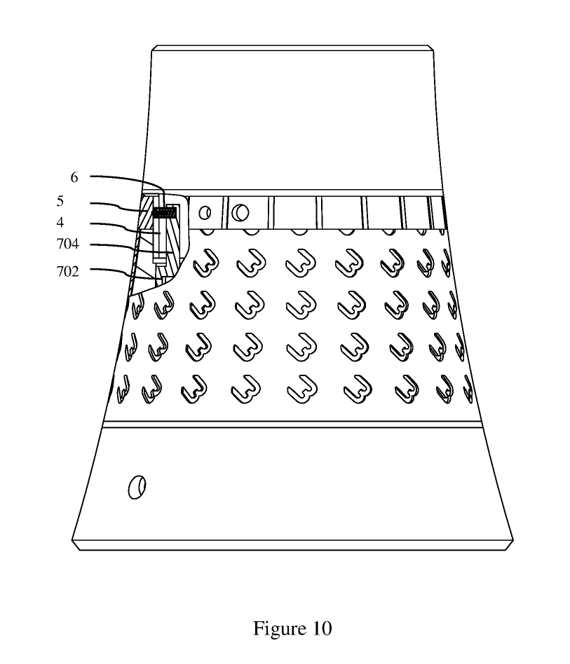

As shown in FIG. 10, one end of the elastic positioning portion 6 is defined at the fixing support 704 of an end surface of the internal support 702, while the other end passes through the openings 401 of the connecting member 4 and is abutted against the inner sidewall of the adjusting member 5.

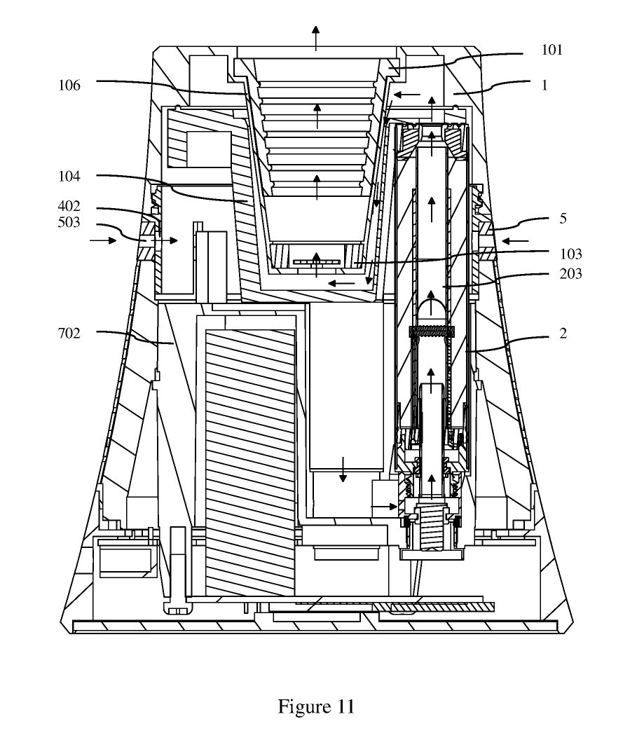

FIG. 11 shows a schematic diagram of air flows inside the electronic cigarette provided by the present embodiment, as shown in the FIG. 11, when users inhale, outer air enters a space between the adjusting member 5 and the sealing piece 104 through the first air inlets 503 and the second air inlets 402 on the left side of FIG. 11, then the air flows along a gap between the sealing piece 104 and the internal support 702, flowing from a vent at an end of the atomization assembly 2 which is opposite to the nozzle assembly 1 into the atomization core 203 of the atomization assembly 2 to form smoke; meanwhile, the outer air also enters through the first air inlets 503 and the second air inlets 402 on the right side of FIG. 11, and flows along a gap between the atomization assembly 2 and the installing support 7 to enter the atomization core 203 via a vent.

After entering the atomization core 203, the air has formed the smoke, the smoke flows out of the atomization assembly 2 along a smoke channel in the atomization core 203, then enters a gap between the sealing piece 104 and the nozzle internal sleeve 106, and flows into the nozzle internal sleeve 106 via the check valve 103 which is opened, finally through the nozzle sleeve 101 to enter the mouth of the user.

When users inhale, the adjusting member 5 is rotated according to the number of users to select one of the first air inlets 503 with a suitable size; when many users use the electronic cigarette at the same time, the first air inlets 503 with a large diameter are selected to communicated with the second air inlets 402, when a single user or few users, the first air inlets 503 with a small diameter are selected to communicated with the second air inlets 402. In this way, a volume of a maximum air intake of the electronic cigarette is changed in a unit time, so that the air intake volume of the electronic cigarette can be adjusted.

Rotating the adjusting member 5 to make the adjusting member 5 to rotate within a limiting range defined by the limit groove 502, under an action of an action of the inner elastic portion, the elastic positioning member 6 moves tightly close to the inner wall surface of the adjusting member 5, when the elastic positioning member 6 moves to the positioning holes 501, the elastic positioning member 6 is clamped into one of the positioning holes 501, the second air inlets 402 are communicated with the first air inlets 503. If users are not satisfied with the size of the air intake volume, users can continue to rotate the adjusting member 5, so that the elastic positioning piece 6 is clamped into another positioning hole 501, the second air inlet 402 are communicated with the another positioning hole 501, until the users find one of the first air inlet holes 503 which can make the air intake volume of the electronic cigarette suitable.

Besides, the electronic cigarette is further provided with a charge base 802 to realize a charge of the battery assembly 3.

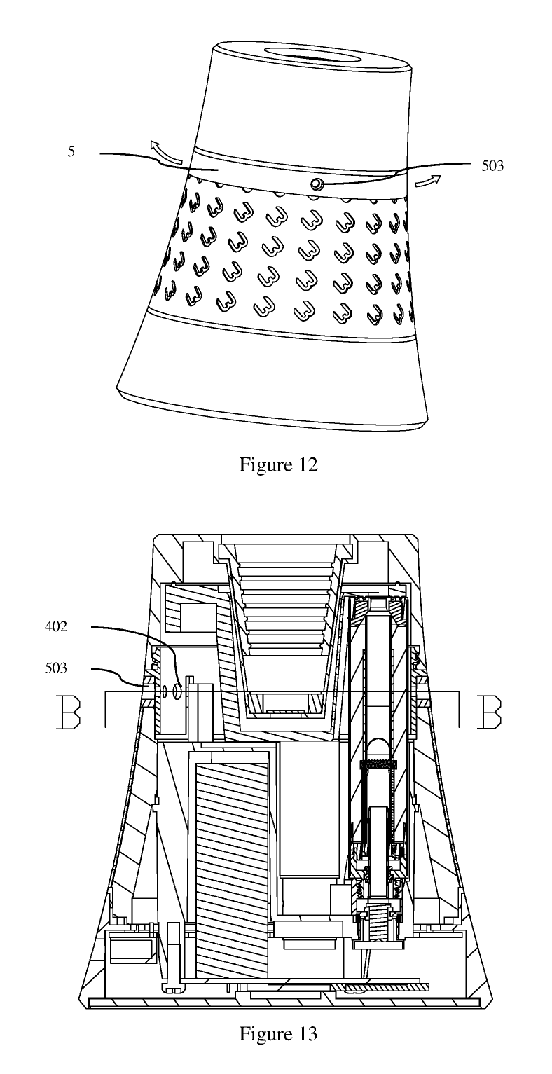

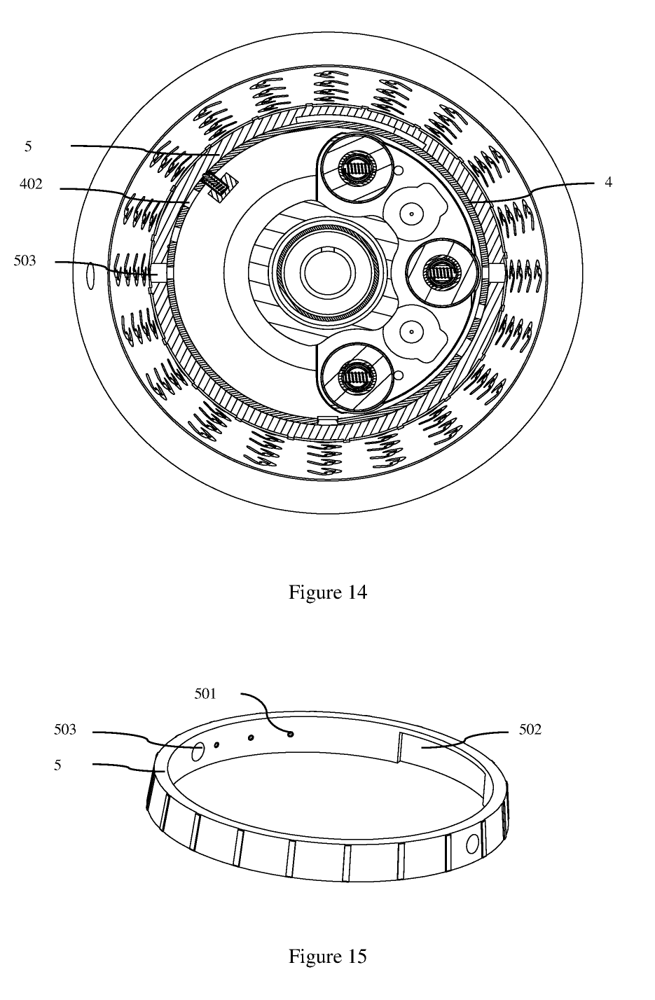

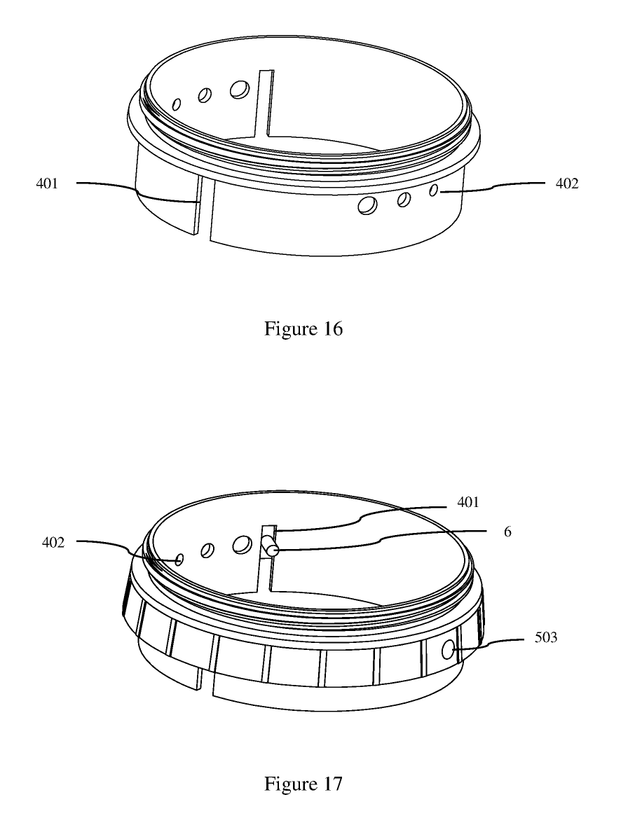

FIGS. 12 to 17 show an electronic cigarette provided by a second preferred embodiment of the present invention, a different point between the second preferred embodiment and the first preferred embodiment is that, at least one first air inlet 503 is defined at the adjusting member 5, and multiple groups of the second air inlets 402 are correspondingly defined at the connecting member 4, each group comprises multiple second air inlets 402 with different diameter sizes. Preferably, quantity of the first air inlets 503 is equaled to quantity of groups of the second air inlets 402.

Also, the adjusting member 5 is also provided with positioning holes 501 which is configured for matching with multiple elastic positioning members 6 to cooperate in positioning, preferably, quantity of the positioning holes 501 is equaled to that of the second air inlets 402 included in each group of the second air inlets 402 on the connecting member 4.

In the present embodiment, two first air inlets 503 are defined on the adjusting member 5, two groups of the second air inlets 402 are defined on the connecting member 4, each group contains three second air inlets 402 respectively; correspondingly, three positioning holes 501 are defined on the adjusting member 5. Rotating the adjusting member 5, when the elastic positioning member 6 is clamped into one of the positioning holes 501, each of the first air inlets 503c is communicated with one of the second air inlets 402 in one corresponding group of the second air inlets 402.

In the present embodiment, quantity of groups of the second air inlets 402 and the second air inlets 402 in each group is selected according to actual needs, and it is not limited here. Other structures and working principle of the present embodiment is the same with those of the above embodiment, and they are not repeated here.

Understandably, shapes of the first air inlets 503 and the second air inlets 402 are not limited to circles, they can be other shapes, as long as the first air inlets 503 and the second air inlets 402 are able to overlap with each other to ensure that external air can enter into the electronic cigarette body.

Also, it can be understood that diameters of multiple second air inlets 402 in each group can be increased or reduced along a clockwise direction, also can be an irregular distribution, a regularity of a distribution of the second air inlets 402 with different diameters on the connecting member 4 is not limited here.

The present invention further provides a method for regulating air intake volume of the electronic cigarette according the previous electronic cigarette, a smoke signal is sensed through airflow sensors 9 in the electronic cigarette body to enable the battery assembly 3 to supply electrical power to the atomization assembly 2 to atomize the tobacco oil; according to a required air intake volume, the adjusting element 5 is rotated along the circumferential direction of the connecting member 4 to adjust the ventilation area at the communicating part of the first air-inlet channel and the second air-inlet channel, and the ventilation area is remained at a selected gear by the positioning mechanism.

In summary, the adjusting element 5 is rotated along the circumferential direction of the connecting member 4 to adjust the ventilation area at the communicating part of the first air-inlet channel and the second air-inlet channel, so as to meet requirements for different air intake volume of users; the positioning mechanism is arranged to further solidify the users' demands for different air intake volumes to limited gear positions, it is not only convenient for users to quickly select the air intake volume needed by themselves, but also avoid a change of the air intake volume due to the wrong touch of the adjusting member 5; besides, as the atomization assembly 2 and the battery assembly 3 are arranged in parallel, then a total length of the electronic cigarette is reduced, and it is easy to carry with a skillful structure design and a well mechanical strength; meanwhile, a larger diameter of the electronic cigarette can increase a smoking and controlling pleasure to meet demands of users who usually smoke cigarettes with large diameters, such as cigars.

Combining with the accompanying drawings, embodiments of the present invention are described. However, the present invention is not limited by the above embodiments, which means that the above specific embodiments are only schematic, rather than restrictive. It should be understood that, in the inspiration of the present invention, those skilled in the art who appreciate and realize all or part of the process in above embodiments may make many modifications or alternatives, without going beyond the purpose and the scope the claims intend to protect of the present application. All these belong to the protection of the present invention.

What is claimed is:

1. An electronic cigarette, comprising an electronic cigarette body, an end of the electronic cigarette body is provided with a nozzle assembly (1), wherein the electronic cigarette body is provided with at least one atomization assembly (2) configured for atomizing tobacco oil and a battery assembly (3) configured for supplying electrical power to each atomization assembly (2); a smoke channel is defined in the each atomization assembly (2) to allow smoke produced by the each atomization assembly (2) to flow through; one end of the smoke channel is communicated with the nozzle assembly (1); and
wherein a connecting member (4) is defined at the electronic cigarette body, an adjusting member (5) is sleeved on the connecting member (4) and is configured to be rotated along a circumferential direction of the connecting member (4); a first air-inlet channel configured for outside air to inflow is defined on the adjusting member (5); a second air-inlet channel communicated with the first air-inlet channel and the smoke channel is defined on the connecting member (4); the adjusting member (5) is rotated along a circumferential direction of the connecting member (4) to adjust a ventilation area of a communicating part of the first air-inlet channel and the second air-inlet channel; the electronic cigarette body further comprises a positioning mechanism which is movably connected to the adjusting member (5) and is configured for limiting the ventilation area in different gear positions.

2. The electronic cigarette according to claim 1, wherein the positioning mechanism comprises an elastic positioning portion (6) fixed on the electronic cigarette body and multiple positioning holes (501) arranged at an inner wall of the adjusting member (5); rotating the adjusting member (5) to enable the elastic positioning portion (6) to be optionally clamped into one of the positioning holes (501) to keep the ventilation area in a corresponding gear.

3. The electronic cigarette according to claim 2, wherein the elastic positioning portion (6) comprises a main body portion (601), an elastic portion and an abutting portion (602), an accommodation space configured for receiving the elastic portion and the abutting portion (602) is defined inside the main body portion (601); and
wherein one end of the elastic portion is abutted inside the accommodation space, while the other end of the elastic portion is connected to the abutting portion (602); one end of the abutting portion (602) is movably defined inside the accommodation space while the other end of the abutting portion (602) extends out of the main body portion (601).

4. The electronic cigarette according to claim 2, wherein the connecting member (4) is provided with openings (401) for the elastic positioning member (6) to pass through; rotating the adjusting member (5), an end of the elastic positioning member (6) passes through the openings (401), and under an action of an elastic restoring force of the elastic positioning member (6), the end of the elastic positioning member (6) moves tightly close to an inner wall surface of the adjusting member (5) until it is clamped into the positioning holes (501).

5. The electronic cigarette according to claim 1, wherein a limiting groove (502) is arranged on an inner wall surface of the adjusting member (5), the electronic cigarette body is extended to form a limit stop block (701) on an end surface close to the nozzle assembly (1); the adjusting member (5) is rotated to move the limit stop block (701) within a limiting range defined by the limit groove (502).

6. The electronic cigarette according to claim 1, wherein the first air-inlet channel comprises at least one group of first air inlets (503), each group of the first air inlets (503) respectively comprises multiple first air inlets (503) with different ventilation areas; the second air-inlet channel comprises second air inlets (402) corresponding to each group of the first air-inlets (503); and
wherein rotating the adjusting member (5), each of the second air inlets (402) can be optionally communicated with one of the each group of first air inlets (503) to adjust a ventilation area at a communicating part of the first air inlets (503) and the second air inlets (402).

7. The electronic cigarette according to claim 6, wherein quantity of the second air inlets (402) of the connecting member (4) is equaled to quantity of groups of the first air-inlets (503) on the adjusting member (5).

8. The electronic cigarette according to claim 1, wherein the second air-inlet channel comprises at least one group of second air inlets (402), each group of the second air inlets (402) respectively comprises multiple second air inlets (402) with different ventilation areas; the first air-inlet channel comprises first air inlets (503) corresponding to each group of the second air inlets (402); and
wherein rotating the adjusting member (5), each of the first air inlets (503) can be optionally communicated with one of the each group of second air inlets (402) to adjust a ventilation area at a communicating part of the first air inlets (503) and the second air inlets (402).

9. The electronic cigarette according to claim 8, wherein quantity of the first air-inlets (503) of the adjusting member (5) is equaled to quantity of groups of the second air-inlets (402) on the connecting member (4).

10. The electronic cigarette according to claim 1, wherein two ends of the connecting member (4) are detachably connected to the nozzle assembly (1) and the electronic cigarette body respectively, the adjusting member (5) is arranged at an end of the nozzle assembly (1) which is opposite to a discharge opening of the electronic cigarette.

11. The electronic cigarette according to claim 1, wherein the electronic cigarette body comprises an installing support (7) configured for receiving the atomization assembly (2) and the battery assembly (3), the installing support (7) comprises an internal support (702) configured for accommodating and fixing the atomization assembly (2) and the battery assembly (3), and an external support (703) sleeved outside the internal support (702), the atomization assembly (2) and the battery assembly (3) are installed in parallel through the internal support (702), the positioning mechanism is fixed at an end of the internal support (702) which is close to the connecting member (4).

12. The electronic cigarette according to claim 11, wherein the electronic cigarette body further comprises a base (8) connected to the installing support (7), the base (8) is provided with a control circuit (801) and a charge base (802), the charge base (802) is configured for charging the battery assembly (3), an end of the battery assembly (3) extends into the base (8) and is electrically connected to the control circuit (801).

13. The electronic cigarette according to claim 1, wherein the nozzle assembly (1) comprises a nozzle sleeve (101) and a nozzle cover (102), the nozzle cover (102) comprises a nozzle external sleeve (105) detachably and mutually connected to the connecting member (4), and a nozzle internal sleeve (106) configured for smoke to flow out, the nozzle external sleeve (105) is sleeved outside the nozzle internal sleeve (106), an end of the nozzle external sleeve (105) which is opposite to the connecting member (4) is connected to an end surface of the nozzle internal sleeve (106), the nozzle sleeve (101) is fixed inside the nozzle internal sleeve (106).

14. The electronic cigarette according to claim 13, wherein the nozzle assembly (1) further comprises a check valve (103) configured for ensuring a one-way flow of the smoke, the check valve (103) is fixed inside the nozzle internal sleeve (106), and an outer sidewall of the check valve (103) and an inner wall surface of the nozzle internal sleeve (106) are completely fitted.

15. The electronic cigarette according to claim 13, wherein the nozzle assembly (1) further comprises a sealing piece (104) installed at a gap between the nozzle internal sleeve (106) and the nozzle external sleeve (105), an mounting hole (107) configured for the nozzle internal sleeve (106) to be inserted into is arranged at an end of the sealing piece (104), a gap between the mounting hole (107) and the nozzle internal sleeve (106) forms a smoke passage configured for smoke to pass through.

16. The electronic cigarette according to claim 1, wherein the each atomization assembly (2) comprises a heating coil assembly (201), a tobacco oil latch member (202) configured for providing the tobacco oil to the heating coil assembly (201), an atomization core (203) configured for receiving the heating coil assembly (201) and an atomization sleeve (204) configured for installing the atomization core (203) and the tobacco oil latch member (202), a first electrode (205) and a second electrode (206) which are configured for being electrically connected to the battery assembly (3) are defined at an end of the atomization core (203), a through hole configured for an oil guide member of the heating coil assembly (201) to pass through is arranged at a sidewall of the atomization core (203), two ends of the oil guide member are inserted into the tobacco oil latch member (202) to absorb the tobacco oil, two ends of the heating coil assembly (201) are electrically connected to the first electrode (205) and the second electrode (206) respectively.

17. The electronic cigarette according to claim 1, wherein the electronic cigarette body comprises multiple atomization assemblies (2) which are arranged in parallel and multiple airflow sensors (9), the airflow sensors (9) and the atomization assembles (2) are distributed around a central axis of the electronic cigarette body, the atomization assemblies (2) and the battery assembly (3) are arranged in parallel.

18. A method for regulating air intake volume of the electronic cigarette according to claim 1, wherein a smoke signal is sensed through airflow sensors (9) which are provided in the electronic cigarette body to enable the battery assembly (3) to supply electrical power to the atomization assembly (2) to atomize the tobacco oil; according to a required air intake volume, the adjusting element (5) is rotated along the circumferential direction of the connecting member (4) to adjust the ventilation area at the communicating part of the first air-inlet channel and the second air-inlet channel, and the ventilation area is remained at a selected gear by the positioning mechanism.
